(19) United States
(12) Patent Application Publication
(10) Pub. No.: US 2008/0285113 A1
(43) Pub. Date: Nov. 20, 2008

(54) Electrophoretic Display Panel

(75) Inventors: Murray Gillies, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,197

(22) PCT Filed: May 11, 2005
(86) PCT No.: PCT/IB05/51544

§ 371 Date: Nov. 16, 2006

(30) Foreign Application Priority Data
May 28, 2004 (EP) 04102383.9

(51) Int. Cl. G02F 1/167

(52) U.S. Cl. 359/296

(57) ABSTRACT

For the electrophoretic display panel (1) to able to have a relatively large number of attainable optical states for displaying the picture, even if the liquid is transparent, the electrophoretic display panel (1) has a magnetic field generator (120) for generating a magnetic field, a pixel (2) having a viewing surface (91) for being viewed by a viewer, electrodes (10,15) for receiving potentials for generating an electric field, an electrophoretic medium (5) having first charged particles (6) and second charged particles (7) having dissimilar optical properties, at least one type of the first and the second particles (6,7) having a net magnetic moment, a combination of the electric and the magnetic field providing a decoupled movement of the first and the second charged particles (6,7) to their respective positions for displaying the picture. Furthermore, the electrodes (10,15) are arranged to enable the particles (10,15) to move in a plane parallel to the viewing surface (91) and the pixel (2) has an optical state depending on the positions of the particles (6,7).

The invention relates to an electrophoretic display panel for displaying a picture.

The invention also relates to a display device comprising such an electrophoretic display panel.

An electrophoretic display panel for displaying a picture is disclosed in WO02/093245.

Electrophoretic display panels in general are based on the motion of charged, usually colored particles under the influence of an electric field between electrodes. With these display panels, dark or colored characters can be imaged on a light or colored background, and vice versa. Electrophoretic display panels are therefore notably used in display devices taking over the function of paper, referred to as “paper white” applications, e.g. electronic newspapers and electronic diaries.

In the disclosed electrophoretic display panel the electrophoretic medium of the pixel comprises a suspending liquid and dispersed therein magnetic, positively charged black particles and non-magnetic, negatively charged white particles. Furthermore, the liquid is transparent. The display panel has a common, transparent front electrode, which forms a viewing surface through which an observer views the pixel, and a rear electrode. The rear electrode is mounted upon a substrate, which contains a magnetic sheet, which may be formed from any convenient magnetic material. The pixel has two attainable optical states, which will be illustrated below.

In a first state the front electrode is positively charged relative to the rear electrode, the size of the potential difference between the electrodes is essentially irrelevant. The positively charged particles are held adjacent to the rear electrode by both magnetic and electrostatic forces, while the negatively charged particles are held electrostatically against the front electrode. Accordingly, an observer viewing the display panel through the front electrode sees a white pixel, since the white particles are visible and hide the black particles.

In a second state the front electrode is slightly negatively charged relative to the rear electrode, the positively charged particles will be weakly attracted to the negatively charged front electrode, but this weak electrostatic attraction is insufficient to overcome the magnetic attraction of the particles to the magnetic sheet. Accordingly, the positively charged particles remain adjacent to the rear electrode. The white particles, which are subject to electrostatic but not magnetic forces, move towards the rear electrode and form a continuous white layer overlying and hiding the layer of black particles. Accordingly, an observer viewing the display through the front electrode still sees a white pixel, since the white particles are visible through the uncolored liquid and hide the black particles.

In a third state the front electrode is highly negatively charged relative to the rear electrode, the positively charged particles are now strongly electrostatically attracted to the highly negative front electrode, and this strong electrostatic attraction is sufficient to overcome the magnetic attraction of the particles to the magnetic sheet. Accordingly, the positively charged particles move adjacent to the front electrode, and the pixel displays the black color of the black particles, which hide the white particles. The first, second and third states show that the attainable optical states are black and white. A relatively large number of attainable optical states is achieved in case the suspending liquid is colored, e.g. red. Then the optical states of the pixel in the previously described first and third cases are still white and black, respectively, whereas in the previously described second case, the optical state of the pixel is red, because the observer sees the red color of the liquid since both the white and black particles are hidden by the red liquid. However, for a transparent liquid the number of attainable optical states is relatively small.

It is an object of the invention to provide an electrophoretic display panel which is able to have a relatively large number of attainable optical states for displaying the picture, even if the liquid is transparent.

To achieve this object, the invention provides an electrophoretic display panel for displaying a picture comprising
a magnetic field generator for generating a magnetic field,
a pixel having
   a viewing surface for being viewed by a viewer,
   electrodes for receiving potentials for generating an electric field,
   an electrophoretic medium comprising first charged particles and second charged particles having dissimilar optical properties, at least one type of the first and the second particles having a net magnetic moment, a combination of the electric and the magnetic field providing a decoupled movement of the first and the second charged particles to their respective positions for displaying the picture, the electrodes being arranged to enable the particles to move in a plane parallel to the viewing surface, and
   an optical state depending on the positions of the particles. As at least one type of the first and the second particles has a net magnetic moment, the movement of the first particles is decoupled from the movement of the second particles by the combination of the electric and the magnetic field. Furthermore, the first and/or the second particles can be removed from a portion of the pixel contributing to the optical state as the movement has a component in a plane parallel to the viewing surface. The then resulting optical state is different from the optical states obtained by having solely the first or solely the second particles near the viewing surface. Furthermore, drive means are arranged for controlling the potentials.

In an embodiment the decoupling is provided by dissimilar potential thresholds for the first and the second particles for being displaced from a position adjacent to a member of the electrodes, at least one of the potential thresholds resulting from an attracting magnetic force on one type of magnetic particles in the magnetic field towards a member of the electrodes in the position adjacent to the member.

The magnetic field generator may be an activated solenoid. If the magnetic field generator is a permanent magnet, the display panel can relatively easily be manufactured and the power consumption is relatively small. If, furthermore, the magnet is adjacent to or part of the member, the amount of magnetic material used can be relatively small. If, furthermore, the member has a substantially flat surface facing the particles, the surface being substantially perpendicular to the viewing surface, the display panel may even be used in light transmissive mode.

In an embodiment the electrodes have substantially flat surfaces facing the particles and the surfaces are substantially parallel to the viewing surface. Then the geometry of the electrodes and surfaces of the electrodes can be relatively simply manufactured. If, furthermore, the surfaces of the electrodes are present in a substantially flat plane, the manufacturing process of the electrodes is further simplified.

In another embodiment the pixel comprises a reservoir portion substantially non-contributing to the optical state of pixel and an optical active portion substantially contributing to the optical state of pixel. Then the particles in the reservoir are hidden from the viewer. If, furthermore, the movement of the particles comprises a reset-movement of the particles into the reservoir portion, and subsequently a picture-movement of the particles to the position for displaying the picture, then the accuracy of the picture is improved.

In another embodiment each member of the electrodes comprises a magnet. Then the accuracy of the picture is improved.

In another embodiment the second particles are substantially non-magnetic. Then the second particles can relatively easily be manufactured.

In another embodiment the electrophoretic medium comprises third and fourth charged particles; the first, the second, the third and the fourth particles having mutually dissimilar optical properties; the sign of the charge of the first and the second particles being equal and being opposite to the sign of the charge of the third and the fourth particles; the second and fourth particles being substantially non-magnetic; the first and the third particles having net magnetic moments. Then the pixel has an even larger number of attainable optical states.

In another embodiment, the display panel is an active matrix display panel.

Another aspect of the invention provides a display device comprising an electrophoretic display panel as claimed in claim 15.

These and other aspects of the display panel of the invention will be further elucidated and described with reference to the drawings, in which:

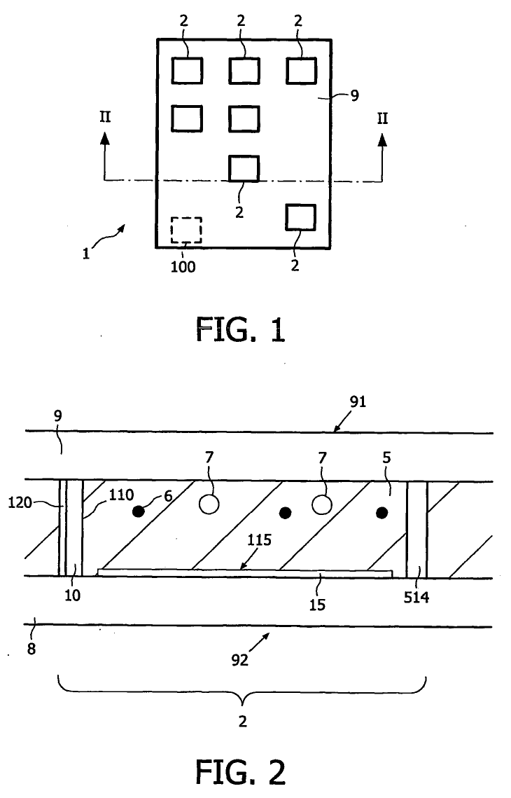

FIG. 1 shows diagrammatically a front view of an embodiment of the display panel;

FIG. 2 shows diagrammatically a cross-sectional view along II-II in FIG. 1;

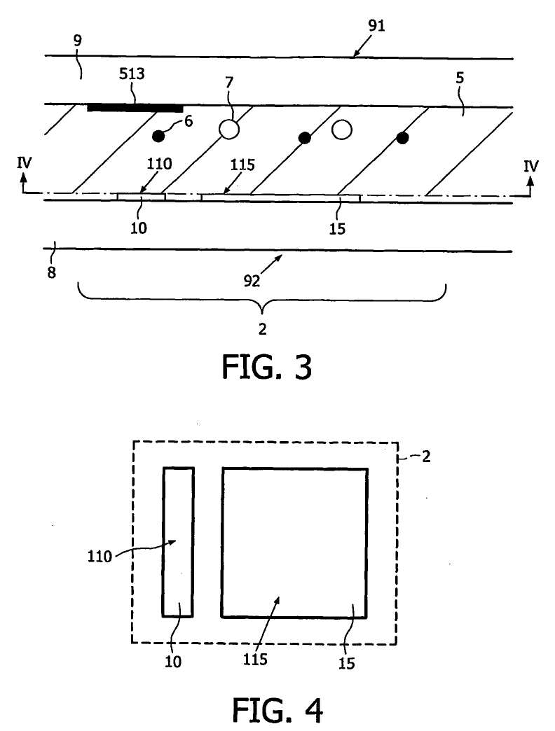

FIG. 3 shows diagrammatically a cross-sectional view along II-II in FIG. 1 of another embodiment of the display panel;

FIG. 4 shows diagrammatically a cross-sectional view along IV-IV in FIG. 3, the cross-sectional view representing a layout of the electrodes of a pixel;

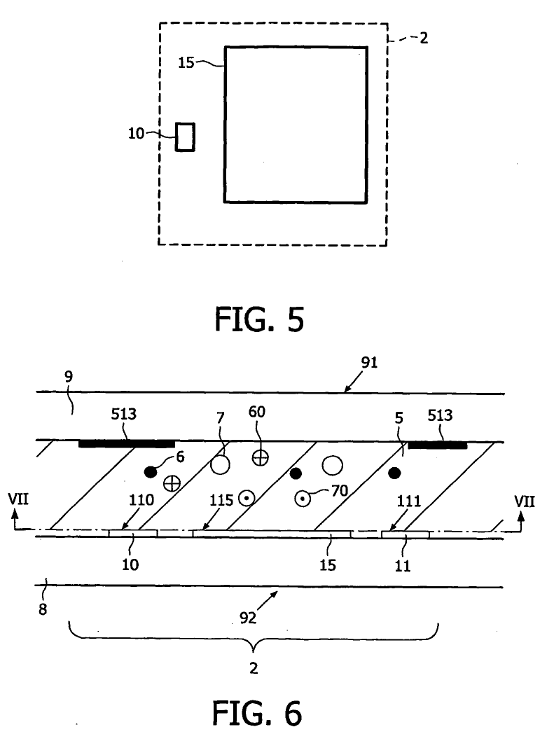

FIG. 5 shows diagrammatically another layout of the electrodes of a pixel;

FIG. 6 shows diagrammatically a cross-sectional view along II-II in FIG. 1 of another embodiment of the display panel; and

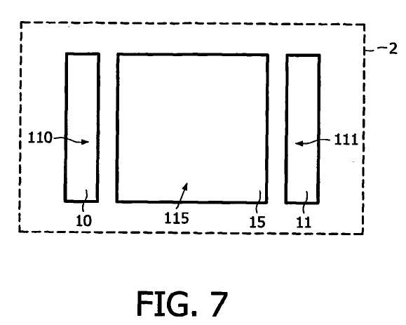

FIG. 7 shows diagrammatically a cross-sectional view along VII-VII in FIG. 6, the cross-sectional view representing a layout of the electrodes of a pixel.

In all the Figures corresponding parts are referenced to by the same reference numerals.

FIGS. 1 and 2 show an example of the display panel 1 having a first substrate 8, a second transparent opposed substrate 9 and a plurality of pixels 2. Preferably, the pixels 2 are arranged along substantially straight lines in a two-dimensional structure. Other arrangements of the pixels 2 are alternatively possible, e.g. a honeycomb arrangement. In an active matrix embodiment, the pixels 2 may further comprise switching electronics, for example, thin film transistors (TFTs), diodes, MIM devices or the like.

An electrophoretic medium 5, having first charged and second charged particles 6,7 in a transparant fluid, is present between the substrates 8,9. At least one type of the first and the second particles 6,7 has a net magnetic moment, e.g. is ferromagnetic. Electrophoretic media 5 having charged particles with magnetic properties are known per se from e.g. WO02/093245, this document being incorporated by reference herein. The particles are e.g. formed of iron tetroxide (Fe3O4), usually known as “magnetite” or “lodestone”, the most common mineral forms of this material. This material is inexpensive and can readily be reduced to the particle size range (about 0.25 to 5 micron) normally used in electrophoretic displays. The magnetic particles have preferable a low magnetic coercivity to avoid unnecessary clustering in the absence of a magnetic field. Magnetite itself is of course black in color. In many embodiments of the invention, the magnetite may be used in this black form. However, in other cases, magnetic particles of other colors may be desired, and in such cases the magnetic particles may comprise magnetite coated with another pigment. For example, if white magnetic particles are desired, magnetite could be coated with titania by conventional processes such as those used commercially to coat titania on to mica. More generally, the magnetic particles used in the present invention may comprise a core of magnetic material and a shell of non-magnetic material substantially completely surrounding the core; the shell may itself bear a polymer coating or other surface treatment.

The pixel 2 has a viewing surface 91 for being viewed by a viewer. The optical state of the pixel 2 depends on the positions of the first and the second particles 6,7.

The first particles 6 may have any color, whereas the second particles 7 may have any color different from the color of the first particles 6. The color of the first particles 6 is for instance red, green, blue, yellow, cyan, magenta, white or black. Consider the first particles 6 to be positively charged, magnetic and to have a red color, and the second particles 7 to be positively charged, non-magnetic and to have a green color.

The pixel 2 has electrodes 10,15 which receive potentials from the drive means 100. In this case, each one of the electrodes 10,15 has a substantially flat surface 110,115 facing the particles 6,7. The drive means 100 are arranged for controlling the potentials to enable a movement of the particles 6,7 to their positions for displaying the picture. Furthermore, the electrodes 10,15 are arranged to enable the movement to have a component in a plane parallel to the viewing surface 91.

The display panel 1 has a magnetic sheet 120, which may be formed from any convenient magnetic material, for example bonded ferrite, ceramic hard ferrite, aluminum-nickel-cobalt alloys (Alnico), or a rare earth magnetic material, such as samarium cobalt or neodymium iron boron. The magnetic material should have north and south poles such that the magnetic particles experience in a position adjacent to a member of the electrodes 10,15 an attracting magnetic force towards the member. For example, the magnetic material has north and south poles alternating transversely across the width of the magnetic sheet 120, with poling widths less than about 500 micron. Such magnets may be purchased from Group Arnold (300 N. West St., Marengo, Ill., 60152—Group Arnold is a Registered Trademark). As an example the magnetic sheet 120 may lie adjacent to electrode 15. Alternatively, the magnetic sheet 120 may be incorporated into the first substrate 8 or lie between the electrode 15 and the first substrate 8. The magnetic sheet 120 may even be incorporated into the electrode 15. Furthermore, this also applies mutatis mutandis for a magnetic sheet adjacent to electrode 10, whereas even both electrodes 10,15 may comprise magnetic material.

In the embodiment of FIG. 2 the positions of the particles 6,7 and the surface 115 of electrode 15 determine the optical state of the pixel 2. Consider the surface 115 of electrode 15 to be blue. The magnetic sheet 120 lies adjacent electrode 10. This has the effect of creating an extra force for holding the magnetic particles on electrode 10. In this embodiment the display panel 1 is used in light reflective mode. It is furthermore assumed that if an electric field is created between the electrodes 10 and 15 that the electric field created with a potential difference of 5 Volts is sufficient to displace only the nonmagnetic particles from electrode 10 and that an electric field created with a potential difference of 10 Volts is sufficient to displace both nonmagnetic and magnetic particles from electrode 10, i.e. this electric field creates sufficient electrostatic force to outweigh the magnetic attraction of the magnetic particles towards electrode 10.

To obtain an optical state being blue the red and green particles 6,7 are brought in their collected state near the surface 110 of electrode 10, by appropriately changing the potentials received by the electrodes 10,15, e.g. the electrodes 10,15 receive −10 Volts and 0 Volts, respectively. The movement of the particles 6,7 has a component in the plane parallel to the viewing surface 91 and the particles 6,7 are brought substantially outside the light path. Therefore, the optical state of the pixel 2 is blue, as the surface 115 of the electrode 15 is blue.

To subsequently obtain an optical state being green the potential of electrode 15 is switched to −5 Volts and the electrode 10 is set to 0 Volts. Due to the magnetic attraction between electrode 10 and the magnetic particles 6, the electric field is insufficient to switch the red particles 6 and only the green particles 7 are brought near the surface 115 of electrode 15.

To subsequently obtain an optical state being red the potential of electrode 15 is switched to −10 Volts and the electrode 10 is set to 0 Volts. The electric force on the particles 6 as a result of this potential difference is large enough to overcome the attracting magnetic force on the particles 6 towards electrode 10 and the red particles 6 are brought near the surface 115 of electrode 15, covering the green particles 7.

In this way a 2 particle electrophoretic pixel 2 is envisaged with a magnetic sorting mechanism.

If in the embodiment of FIG. 2 electrode 15 and substrate 8 are also transparent, the display panel 1 may be used in light transmissive mode. In transmissive mode, the optical state of the pixel 2 is determined by the portion of the visible spectrum incident on the pixel 2 at the side 92 of the first substrate 8 that survives the cumulative effect of traversing through the first substrate 8, electrode 15, medium 5 and the second substrate 9.

FIGS. 3 and 4 show another embodiment. This embodiment is similar to the previous embodiment shown in FIG. 2. However, in this embodiment, each one of the electrodes 10,15 has a substantially flat surface 110,115 facing the viewing surface 91. Furthermore, the surfaces 110,115 of the electrodes 10,15 are present in a substantially flat plane. The region near the surface 110 of electrode 10 provides a reservoir for the red and green particles 6,7 and is substantially non-contributing to the optical state of the pixel 2. This is achieved by shielding electrode 10 from the viewer by e.g. having a light absorbing layer like a black matrix layer 513 between electrode 10 and the observer. An alternative way of achieving this is by having the surface area of electrode 15 as seen by a viewer at least one order of magnitude larger than the surface area of electrode 10 as seen by a viewer, as shown in FIG. 5. In the embodiment of FIGS. 3 and 4 the position of the particles 6,7 and the surface 115 of electrode 15 determine the optical state of the pixel 2. The two electrodes 10,15 each incorporate a magnetic sheet This has the effect of creating an extra force for holding the magnetic particles on the electrodes. In this embodiment the display panel 1 is used in light reflective mode. It is furthermore assumed that if an electric field is created between the electrodes 10 and 15 that the electric field created with a potential difference of 5 Volts is sufficient to displace only the nonmagnetic particles from the electrodes and that an electric field created with 10 Volts is sufficient to displace both nonmagnetic and magnetic particles i.e. this electric field creates sufficient electrostatic force to outweigh the magnetic attraction between magnetic particles and the magnetic electrode. To obtain an optical state being blue the red and green particles 6,7 are brought into the reservoir, i.e. near the surface 110 of electrode 10, by appropriately changing the potentials received by the electrodes 10,15, e.g. the electrodes 10,15 receive −10 Volts and 0 Volts, respectively. The electric force on the particles 6 as a result of this potential difference is considered to be large enough to overcome the attracting magnetic force on the particles 6 towards electrode 15. As a result the particles 6,7 are hidden from the viewer. Therefore, the optical state of the pixel 2 is blue, as the surface 115 of the electrode 15 is blue.

The process of obtaining different colors is now considered. The first action before displaying a new color is to reset the pixel 2: the red and the green particles 6,7 are brought into the reservoir, by appropriately changing the potentials received by the electrodes 10,15, e.g. the electrodes 10,15 receive −10 Volts and 0 Volts, respectively. The positively charged particles 6,7 are attracted towards electrode 10, independent of the magnetic properties.

To obtain an optical state being green the potential of electrode 15 is switched to −5 Volts and the electrode 10 is set to 0 Volts. Due to the magnetic attraction between electrode 10 and the magnetic particles 6, the electric field is insufficient to switch the red particles 6 and only the green particles 7 are brought near the surface 115 of electrode 15.

To obtain an optical state being red a slightly more complicated driving scheme is required. Firstly, electrode 15 receives a potential of −10 Volts. The electrode 10 from where the red particles 6 are sourced is held at 0 Volts. This creates an electric field that is sufficient to switch both the magnetic red and the nonmagnetic green particles 6,7 to electrode 15. Then the electrodes 10,15 receive potentials of −5 Volts and 0 Volts, respectively. By doing this the non magnetic green particles 7 are returned to electrode 10 leaving the magnetic red particles 6 on electrode 15. In this way a 2 particle electrophoretic pixel 2 is envisaged with a magnetic sorting mechanism. Different intensity levels can be obtained by tuning the values of the potentials applied to the electrodes 10,15.

FIGS. 6 and 7 show another embodiment. The electrophoretic medium 5 has first, second, third and fourth charged particles 6,7,60,70 in a transparant fluid. Consider the first particles 6 to be positively charged, magnetic and to have a red color, the second particles 7 to be positively charged, non-magnetic and to have a green color, the third particles 60 to be negatively charged, magnetic and to have a blue color, and the fourth particles 70 to be negatively charged, non-magnetic and to have a black color. Furthermore, each one of the electrodes 10,11,15 has a substantially flat surface 110,111,115 facing the particles 6,7,60,70 and the viewing surface 91. Furthermore, the surfaces 110,111,115 of the electrodes 10,11,15 are present in a substantially flat plane. The region near the surface 110 of electrode 10 provides a first reservoir for the red and green particles 6,7 and is substantially non-contributing to the optical state of the pixel 2. This is achieved by a black matrix layer 513 between electrode 10 and the observer. The region near the surface 111 of electrode 11 provides a second reservoir for the blue and black particles 60,70 and is substantially non-contributing to the optical state of the pixel 2. This is also achieved by a black matrix layer 513 between electrode 11 and the observer. The position of the particles 6,7,60,70 and the surface 115 of electrode 15 determine the optical state of the pixel 2. Consider the surface 115 of electrode 15 to be white. The three electrodes 10,11,15 each incorporate a magnetic sheet, preferably with a vertical anisotropy (a Co/Pt or Co/Cr multilayer magnet would be a good electrode material). This has the effect of creating an extra force for holding the magnetic particles on the electrodes. In this embodiment the display panel 1 is used in light reflective mode.

It is furthermore assumed that if an electric field is created between the central electrode 15 and one of the side- electrodes 10,11 that the electric field created with a potential of ±5 Volts is sufficient to displace only the nonmagnetic particles from the electrodes and that an electric field created with ±10 Volts is sufficient to displace both nonmagnetic and magnetic particles i.e. this electric field creates sufficient electrostatic force to outweigh the magnetic attraction between magnetic particles and the magnetic electrode.
The process of obtaining different colors is now considered. The first action before displaying a new color is to reset the pixel 2: the red and the green particles 6,7 are brought into the first reservoir and the blue and the black particles 60,70 are brought into the second reservoir, by appropriately changing the potentials received by the electrodes 10,11,15, e.g. the electrodes 10,11,15 receive −10 Volts, 10 Volts and 0 Volts, respectively. The positively charged particles 6,7 are attracted towards side electrode 10 whereas the negatively charged particles 60,70 are attracted towards side electrode 11, independent of magnetic properties.

Obtaining a color associated with one of the non-magnetic particles 7,70 is the most simple and is now described. To obtain an optical state being green the potential of the central electrode 115 is switched to −5 Volts and the electrode 10 from which green has to be attracted is set to 0 Volts. At the same time the opposite side-electrode 11 (from which no particles are required) is set to the central electrode potential of −5 Volts. Due to the magnetic attraction between the side-electrodes 10,11 and the magnetic particles 6,60, respectively, the electric field is insufficient to switch either the red or blue particles 6,60.

To obtain an optical state being black the potential of the central electrode 115 is switched to 5 Volts and the electrode 11 from which black has to be attracted is set to 0 Volts. At the same time the opposite side-electrode 10 (from which no particles are required) is set to the central electrode potential of 5 Volts. Due to the magnetic attraction between the side-electrodes 10,11 and the magnetic particles 6,60, respectively the electric field is insufficient to switch either the red or blue particles 6,60.

In order to obtain a color associated with one of the magnetic particles 6,60 a slightly more complicated driving scheme is required. To obtain an optical state being red, the central electrode 15 receives a potential of −10 Volts. The side-electrode 10 from where the red particles 6 are sourced is held at 0 Volts and the other side-electrode 11 has the same potential as the central electrode, being −10 Volts. This creates an electric field that is sufficient to switch both the magnetic red and the nonmagnetic green particles 6,7 to the central electrode 15. Then the electrodes 10,11,15 receive potentials of −5 Volts, 0 Volts and 0 Volts. By doing this the non magnetic green particles 7 are returned to the side electrode 10 leaving the magnetic red particles 6 on the central electrode 15.

To obtain an optical state being blue, the central electrode 15 receives a potential of 10 Volts. The side-electrode 11 from where the blue particles 60 are sourced is held at 0 Volts and the other side-electrode 10 has the same potential as the central electrode, being 10 Volts. This creates an electric field that is sufficient to switch both the magnetic blue and the nonmagnetic black particles 60,70 to the central electrode 15. Then the electrodes 10,11,15 receive potentials of 0 Volts, 5 Volts and 0 Volts. By doing this the non magnetic black particles 70 are returned to the side electrode 11 leaving the magnetic blue particles 60 on the central electrode 15. In this way a 4 particle electrophoretic pixel 2 is envisaged with a magnetic sorting mechanism. Different intensity levels can be obtained by tuning the values of the potentials applied to the electrodes 10,11,15.

1. An electrophoretic display panel (1) for displaying a picture comprising
a magnetic field generator (120) for generating a magnetic field,
a pixel (2) having
a viewing surface (91) for being viewed by a viewer,
electrodes (10,15) for receiving potentials for generating an electric field, an electrophoretic medium (5) comprising first charged particles (6) and second charged particles (7) having dissimilar optical properties, at least one type of the first and the second particles (6,7) having a net magnetic moment, a combination of the electric and the magnetic field providing a decoupled movement of the first and the second charged particles (6,7) to their respective positions for displaying the picture, the electrodes (10,15) being arranged to enable the particles (6,7) to move in a plane parallel to the viewing surface (91), and
an optical state depending on the positions of the particles (6,7).

2. A display panel (1) as claimed in claim 1 characterized in that the decoupling is provided by dissimilar potential thresholds for the first and the second particles (6,7) for being displaced from a position adjacent to a member of the electrodes (10,15), at least one of the potential thresholds resulting from an attracting magnetic force on one type of magnetic particles in the magnetic field towards a member of the electrodes (10,15) in the position adjacent to the member.

3. A display panel (1) as claimed in claim 1 characterized in that the magnetic field generator (120) is a permanent magnet.

4. A display panel (1) as claimed in claim 3 characterized in that the magnet is adjacent to or part of the member.

5. A display panel (1) as claimed in claim 4 characterized in that the member has a substantially flat surface facing the particles (6,7), the surface being substantially perpendicular to the viewing surface (91).

6. A display panel (1) as claimed in claim 1 characterized in that the electrodes (10,15) have substantially flat surfaces facing the particles (6,7) and the surfaces are substantially parallel to the viewing surface (91).

7. A display panel (1) as claimed in claim 6 characterized in that the surfaces of the electrodes (10,15) are present in a substantially flat plane.

8. A display panel (1) as claimed in claim 1 characterized in that the pixel (2) comprises a reservoir portion substantially non-contributing to the optical state of pixel (2) and an optical active portion substantially contributing to the optical state of pixel (2).

9. A display panel (1) as claimed in claim 8 characterized in that the movement of the particles (6,7) comprises a reset-movement of the particles (6,7) into the reservoir portion, and subsequently a picture-movement of the particles (6,7) to the position for displaying the picture.

10. A display panel (1) as claimed in claim 8 characterized in that the movement of the particles (6,7) comprises a reset-movement of the particles (6,7) into the optical active portion, and subsequently a picture-movement of the particles (6,7) not necessary for display to the reservoir position.

11. A display panel (1) as claimed in claim 1 characterized in that each member of the electrodes comprises a magnet.

12. A display panel (1) as claimed in claim 1 characterized in that the magnetic particles have a soft magnetic component.

13. A display panel (1) as claimed in claim 1 characterized in that the second particles (7) are substantially non-magnetic.

14. A display panel (1) as claimed in claim 1 characterized in that the electrophoretic medium (5) comprises third and fourth charged particles (60,70); the first, the second, the third and the fourth particles (6,7,60,70) having mutually dissimilar optical properties; the sign of the charge of the first and the second particles (6,7) being equal and being opposite to the sign of the charge of the third and the fourth particles (60,70); the second and fourth particles (7,70) being substantially non-magnetic; the first and the third particles (6, 60) having net magnetic moments.

15. A display device comprising the display panel (1) as claimed in claim 1 and a circuitry to provide image information to the panel.
